(19) United States
(12) Patent Application Publication
(10) Pub. No.: US 2015/0088643 A1
(43) Pub. Date: Mar. 26, 2015

(54) METHOD AND SYSTEM FOR LINKING SOCIAL DATA INSTANTANEOUSLY TO PURCHASE TRANSACTIONS

(71) Applicant: MasterCard International Incorporated, Purchase, NY (US)

(72) Inventors: Randall K. Shuken, Westport, CT (US); Debashis Ghosh, Charlotte, NC (US); Mary Elizabeth Lesbirel, Holmdel, NJ (US)

(73) Assignee: MasterCard International Incorporated, Purchase, NY (US)

(21) Appl. No.: 14/038,032

(22) Filed: Sep. 26, 2013

(51) Int. Cl. G06Q 50/00; G06Q 30/02

(52) U.S. Cl. CPC G06Q 50/01; G06Q 30/0253
USPC 705/14.51

(57) ABSTRACT

A method for generating a social network message linked to a payment transaction includes: storing a plurality of consumer profiles, each profile including data related to a consumer including a consumer identifier, social network identifier, device identifier, and preferences; receiving an authorization request for a payment transaction, the request including transaction data and a specific consumer identifier; identifying a specific consumer profile wherein the included consumer identifier corresponds to the specific consumer identifier; generating a social network message, the message including the transaction data and the social network identifier included in the specific consumer profile and generated pursuant to the preferences included in the specific consumer profile; transmitting the social network message to a computing device corresponding to the device identifier included in the specific consumer profile; receiving an indication of approval of the social network message; and transmitting the social network message to a social network for publishing.

### FIELD

The present disclosure relates to the generating of a social network message linked to a purchase transaction, specifically the automatic and instantaneous generation of a message to be published on a social network based on transaction data corresponding to a purchase transaction.

### BACKGROUND

Social networks have provided consumers with the ability to quickly and easily be in contact with a vast number of friends, family members, colleagues, associates, and followers. The ability to quickly reach to a large number of people has led many merchants and retailers to encourage consumers to publish posts, tweets, or other messages to social networks indicating their participation at the merchant as a targeted marketing effort without the expense and resources of traditional marketing methods. However, publishing messages on a social network may take a significant amount of time and effort for a consumer, and thus many consumers may be unwilling to publish a message to their social networks as a benefit to the merchant.

In order to encourage consumers to publish social network messages as advertising, some merchants have begun offering incentives to consumers. For example, some merchants may provide discounts or other offers if a consumer shows proof of a social network post or message regarding their visit, such as the consumer checking-in to the merchant on Foursquare prior to transacting. However, such methods similarly require significant actions to be performed by the consumer and thus may discourage consumers from participating.

In an effort to ease the burden on consumers, some merchants have begun pre-populating messages for posting to social networks as part of the processing of an e-commerce transaction. In some instances, the merchant may request the consumer to publish a message to a social network following a successful transaction, providing the consumer with a pre-populated message advertising the merchant and/or the completed transaction. In such instances, the burden on the consumer is reduced, as the message has been generated for them. However, such methods often require significant modification to existing merchant systems, which may be costly in both time and resources and may accordingly be unavailable to a variety of merchants.

Thus, there is a need for a technical system configured to provide for automatic generation of messages based on purchase or payment transactions for publishing by a social network without requiring modification or expelling of merchant resources.

### SUMMARY

The present disclosure provides a description of systems and methods for generation social network messages linked to purchase transactions.

A method for generating a social network message linked to a payment transaction includes: storing, in a profile database, a plurality of consumer profiles, wherein each consumer profile includes data related to a consumer including at least a consumer identifier, a social network identifier, a device identifier, and one or more preferences; receiving, by a receiving device, an authorization request for a payment transaction, wherein the authorization request includes at least transaction data and a specific consumer identifier; identifying, in the profile database, a specific consumer profile wherein the included consumer identifier corresponds to the specific consumer identifier; generating, by a processing device, a social network message, where the social network message includes at least the transaction data and the social network identifier included in the specific consumer profile and is generated pursuant to the one or more preferences included in the specific consumer profile; transmitting, by a transmitting device, the generated social network message to a computing device corresponding to the device identifier included in the specific consumer profile; receiving, by the receiving device, an indication of approval of the generated social network message from the computing device; and transmitting, by the transmitting device, the generated social network message to a social network for publishing.

A system for generating a social network message linked to a payment transaction includes a profile database, a receiving device, a processing device, and a transmitting device. The profile database is configured to store a plurality of consumer profiles, wherein each consumer profile includes data related to a consumer including at least a consumer identifier, a social network identifier, a device identifier, and one or more preferences. The receiving device is configured to receive an authorization request for a payment transaction, wherein the authorization request includes at least transaction data and a specific consumer identifier. The processing device is configured to: identify, in the profile database, a specific consumer profile where the included consumer identifier corresponds to the specific consumer identifier; and generate a social network message, wherein the social network message includes at least the transaction data and the social network identifier included in the specific consumer profile and is generated pursuant to the one or more preferences included in the specific consumer profile. The transmitting device is configured to transmit the generated social network message to a computing device corresponding to the device identifier included in the specific consumer profile. The receiving device is further configured to receive an indication of approval of the generated social network message from the computing device. The transmitting device is further configured to transmit the generated social network message to a social network for publishing.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for generating social network messages linked to payment transactions in accordance with exemplary embodiments.

FIG. 2 is a block diagram illustrating the processing server of FIG. 1 for the generating of social network messages linked to payment transactions in accordance with exemplary embodiments.

FIG. 3 is a flow diagram illustrating the profile database of the processing server of FIG. 2 for the storing of consumer profiles in accordance with exemplary embodiments.

FIG. 4 is a flow diagram illustrating a process for generating and publishing a social network message based on payment transaction data in accordance with exemplary embodiments.

FIG. 5 is a flow diagram illustrating a method for generating a social network message in accordance with exemplary embodiments.

FIG. 6 is a flow diagram illustrating a method for distributing an offer based on a published social network message in accordance with exemplary embodiments.

FIG. 7 is a flow chart illustrating an exemplary method for generating a social network messaged linked to a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Generating Social Network Messages Linked to Payment Transactions

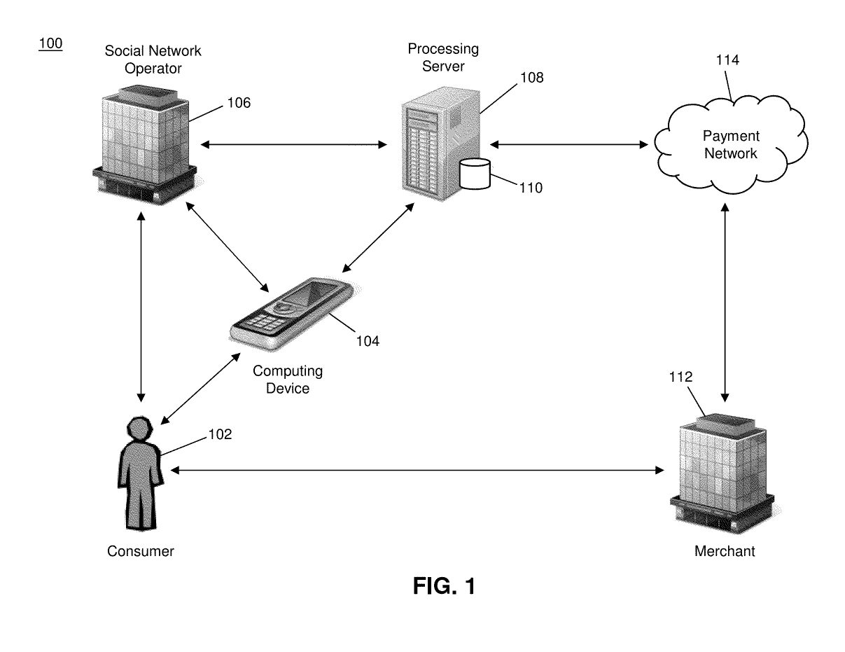

FIG. 1 illustrates a system 100 for generating social network messages including transaction data for a linked payment transaction.

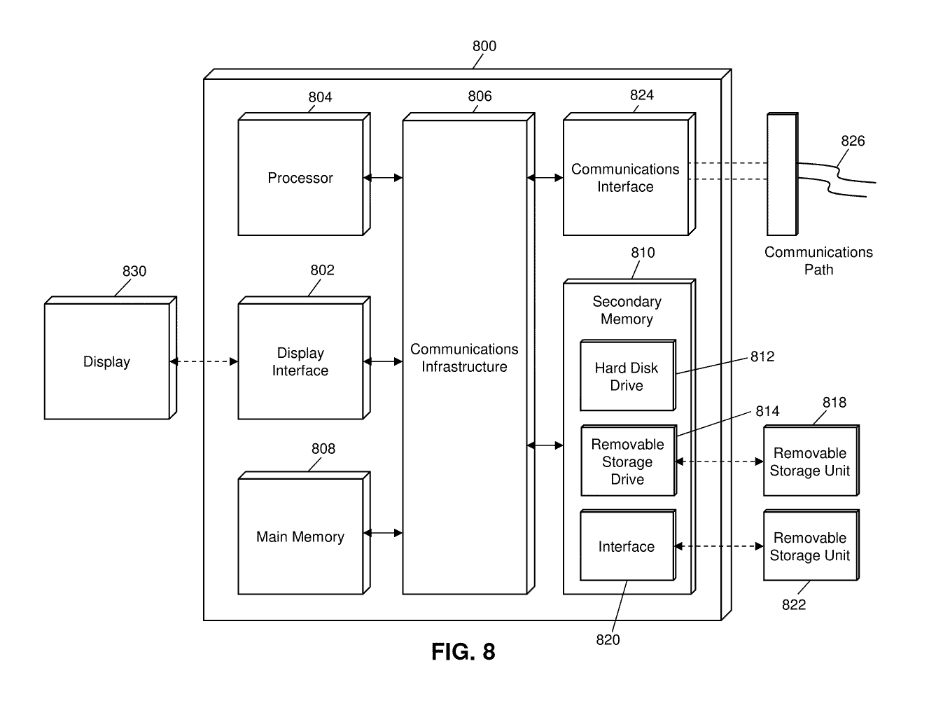

A consumer 102 may use a computing device 104 to access one or more social networks operated by one or more social network operators 106. The computing device 104 may be any type of computing device suitable for performing the functions as disclosed herein, such as a desktop computer, laptop computer, notebook computer, tablet computer, cellular phone, smart phone, point of sale device, etc., or such as the computer system 800 illustrated in FIG. 8 and discussed in more detail below.

The social network operator 106 may operate one or more social networks, such as Facebook®, Twitter®, Myspace®, Google+®, Foursquare®, LinkedIn®, DeviantArt®, Reddit®, Instagram®, Vine®, or any other suitable social network as will be apparent to persons having skill in the relevant art. The consumer 102 may register an account with the social network operator 106 and may receive an identifier to be associated with the consumer 102 for identification of the consumer 102 by the social network operator 106. The social network identifier may be an identification number, username, e-mail address, nickname, or other suitable value as will be apparent to persons having skill in the relevant art.

The social network (e.g., or networks) operated by the social network operator 106 may enable the consumer 102 to post, share, tweet, upload, or otherwise publish content viewable by other consumers. In some instances, the social network may enable the consumer 102 to control the privacy of published content, such as by limiting other consumers that may view the content. For example, some social networks may allow the consumer 102 to limit published content to be viewed only by friends, family, followers, friends of friends, or one or more custom groups of consumers. The social network operator 106 may also provide for additional preferences for the consumer 102 for publishing content, such as by including location information (e.g., the geographic location of the consumer 102 when providing content, such as based on an identified geographic location of the computing device 104 or provided by the consumer 102), or other information (e.g., mood, background entertainment, etc.) that may be provided by the consumer 102, the computing device 104, or other device or entity.

The consumer 102 may, such as by using the computing device 104, register with a service for generating social network messages provided by a processing server 108. The processing server 108, discussed in more detail below, may receive registration information from the consumer 102 for storage in a profile database 110, also discussed in more detail below. The registration information may include at least a social network identifier for a social network operated by the social network operator 106.

The consumer 102 may then engage in a payment transaction with a merchant 112. The merchant 112 (e.g., or an acquirer associated with the merchant 112) may generate an authorization request for the payment transaction, which may be submitted to a payment network 114 for processing. Methods and systems for processing payment transactions will be apparent to persons having skill in the relevant art. The payment network 114 may be configured to transmit the authorization request, or transaction data included therein, to the processing server 108.

The processing server 108 may receive the transaction data, which may include a consumer identifier associated with the consumer 102, such as a payment account number associated with a payment account used to fund the payment transaction. The processing server 108 may identify a consumer profile in the profile database 110 associated with the consumer 102 based on the consumer identifier. The processing server 108 may then generate a social network message for one or more social networks operated by the social network operator 106 based on the transaction data. The transaction data may include, for example, a merchant name, merchant category, payment details, product data, transaction amount, transaction time and/or date, and transaction geographic location.

The generated social network message may include one or more elements of the transaction data. For example, the social network message may express that the consumer 102 recently shopped at the merchant 112, that the consumer 102 purchased a specific product at the merchant 112, that the consumer 102 recently made a purchase using a specific payment card, etc. In some instances, the merchant 112 may specify the content of the generated social network message. In other instances, the consumer 102 may specify the content, such as via one or more preferences established by the consumer 102 and stored in the corresponding consumer profile. Additional considerations for content to be included in the generated social network message will be apparent to persons having skill in the relevant art.

The processing server 108 may transmit the generated social network message to the computing device 104 for approval by the consumer 102. The consumer 102 may approve the social network message, which may prompt the computing device 104 to transmit an indication of approval to the processing server 108. The processing server 108 may then transmit the social network message to the social network operator 106 for publishing to the social network of the consumer 102. In some embodiments, the consumer 102 may modify the social network message and/or set preferences or settings prior to or concurrent with approving the social network message. For example, the consumer 102 may modify the content of the social network message, the social network or networks on which the message is to be published, which consumers and/or groups of consumers may view the message, etc.

The use of the processing server 108 to generate the social network automatically and based on the transaction data for the payment transaction may enable for significantly faster, more efficient, and thereby more prolific publishing of content to social networks. The processing server 108 may enable the publishing of content on behalf of the merchant 112 without modification to existing merchant processing systems. In addition, by generating the message automatically and seeking approval of the consumer 102, the burden of production may be lowered on the consumer 102, which may result in a significant increase in the publishing of social network messages while still enabling the consumer 102 to control content that is to be published.

In some embodiments, the processing server 108 may also obtain offers for the purchase of goods or services from one or more offer providers (e.g., the merchant 112 or a third party). As discussed in more detail below, each offer may include one or more terms of eligibility. The terms of eligibility may include terms under which the corresponding offer is to be distributed to the consumer 102. For example, an offer may be distributed upon any social network message posted regarding the merchant 112, upon reaching a predetermined number of pieces of social network content published regarding the merchant 112, publishing content regarding the merchant 112 among a predefined number of social networks, or other suitable terms as will be apparent to persons having skill in the relevant art.

The processing server 108 may store a history regarding social network messages published for the consumer 102 and may, upon transmitting a new social network message to the social network operator 106, identify any offers for which the consumer 102 may be eligible based on an updated history. The processing server 108 may identify the eligible offers and may transmit them to the consumer 102 (e.g., via the computing device 104 and/or via any suitable method, such as a method selected by the consumer 102). In some instances, the consumer 102 may accept an offer, and the processing server 108 may be notified of the offer acceptance. The processing server 108 may then transmit notification of the acceptance to the offer provider, if necessary.

By identifying eligible offers and transmitting them to the consumer 102, the processing server 108 may further provide for incentives to the publishing of content on a social network, without the need for the merchant 112 to modify existing processing systems or to expend the resources necessary to operate a closed system. As such, the systems and methods discussed herein may generate social network messages linked to payment transactions and the distribution of offers based thereon more efficiently and with greater success than in traditional systems.

### Processing Device

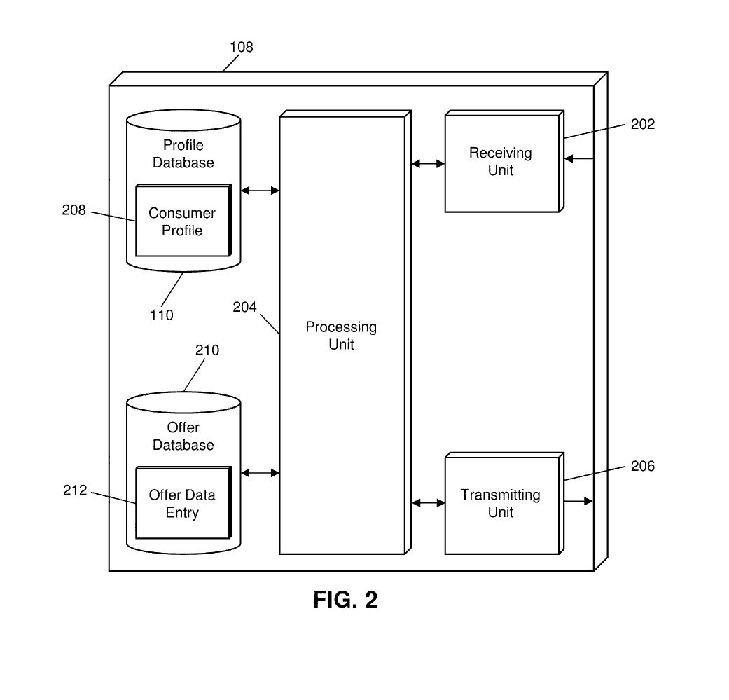

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 800 illustrated in FIG. 8 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive registration information from the consumer 102 (e.g., via the computing device 104), wherein the registration information includes at least a social network identifier, a consumer identifier, and a device identifier for the computing device 104 which the consumer 102 will use to approve social network messages. In some embodiments, the registration information may also include one or more consumer preferences.

The processing server 108 may further include a processing unit 204. The processing unit 204 may be configured to generate a consumer profile 208 based on the received registration information and store the generated consumer profile 208 in the profile database 110. The consumer profile 208, discussed in more detail below, may include the consumer identifier, the social network identifier, the device identifier, and the one or more preferences.

The receiving unit 202 may further receive an authorization request for a payment transaction involving the consumer 102. The authorization request may include at least the consumer identifier associated with the consumer 102 and transaction data. The processing unit 204 may identify the consumer profile 208 in the profile database 110 including the consumer identifier included in the authorization request. The processing unit 204 may be further configured to generate a social network message based on the transaction data for publishing on a social network associated with the social network identifier included in the consumer profile 208.

The processing server 108 may include a transmitting unit 206. The transmitting unit 206 may be configured to transmit data over one or more networks via one or more network protocols. The transmitting unit 206 may transmit the generated social network message to the computing device 104 associated with the device identifier included in the consumer profile 208. The receiving unit 202 may then receive an indication of approval from the computing device 104.

If the indication of approval includes requested modifications to the social network message or preferences or parameters for its publishing, the processing unit 204 may be configured to make the requested changes. The transmitting unit 206 may then transmit the modified social network message to the social network operator 106 for publishing.

In some embodiments, the receiving unit 202 may be configured to receive offer data for one or more offers for the purchase of goods or services. The processing unit 204 may be configured to generate an offer data entry 212 corresponding to each received offer, and store the offer data entries 212 in an offer database 210. Each offer data entry 212 may include at least a merchant identifier (e.g., associated with the merchant 112 with whom the corresponding offer may be redeemed) and/or limits on eligibility.

The processing unit 204 may be configured to update a social network history in the consumer profile 208 for the consumer 102 when a social network message is transmitted to the social network operator 106 for publishing. The processing unit 204 may be further configured to identify offer data entries 212 corresponding to offers for which the consumer 102 may be eligible based on the consumer social network history and the limits on eligibility for each corresponding offer data entry 212. The transmitting unit 206 may then transmit offer data for the eligible offers to the computing device 104 or via a method indicated by the consumer 102 (e.g., and stored in the consumer profile 208). Methods for transmitting offer data to the consumer 102 may include e-mail, traditional mail, short message service message, multimedia message service message, via an application program executed by the computing device 104, or other suitable method as will be apparent to persons having skill in the relevant art.

In a further embodiment, the receiving unit 202 may be configured to receive an indication from the computing device 104 of the acceptance of an offer by the consumer 102. The transmitting unit 206 may forward the acceptance of the offer to a corresponding offer provider (e.g., the merchant 112 or a third party).

### Consumer Profiles

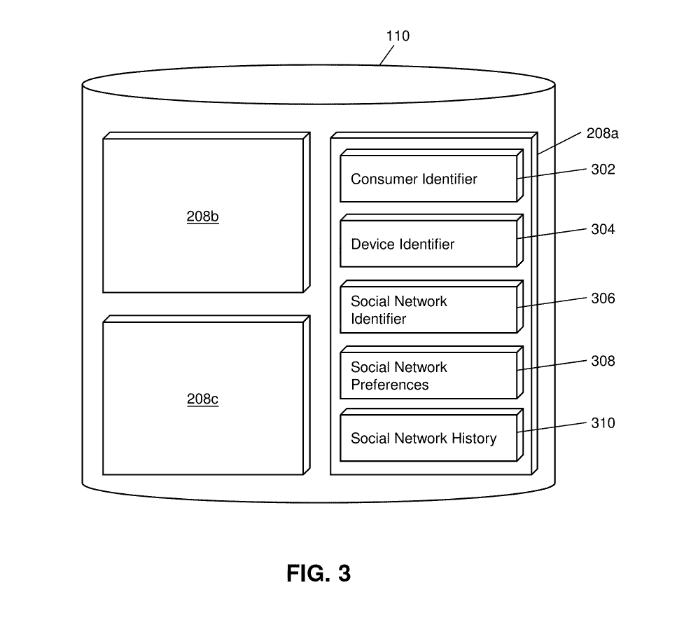

FIG. 3 illustrates the profile database 110 configured to store a plurality of consumer profiles 208, illustrated in FIG. 3 as consumer profiles 208a, 208b, and 208c. Each consumer profile 208 may include at least a consumer identifier 302, a device identifier 304, a social network identifier 306, and one or more social network preferences 308. In some embodiments, each consumer profile 208 may further include a social network history 310. Additional data that may be included in each consumer profile 208, such as preferred methods of distribution for offers, additional social network identifiers 306, data for the targeting of offers (e.g., demographic data), etc. will be apparent to persons having skill in the relevant art.

The consumer identifier 302 may be a unique value associated with a consumer 102 that may be used to identify the corresponding consumer profile 208 as related to the associated consumer 102. The consumer identifier 302 may be an identification number, username, e-mail address, name, street address, phone number, or any other suitable value as will be apparent to persons having skill in the relevant art. In one embodiment, the consumer identifier 302 may be a payment account number corresponding to a payment account associated with the consumer 102. In such an embodiment, a received authorization request may include the payment account number, which may result in a fast and efficient identification of the consumer profile 208 using the payment account number as the consumer identifier 302.

The device identifier 304 may be a unique value associated with the computing device 104 to which the generated social network message is to be sent for approval. The device identifier 304 may be a media access control address, an internet protocol address, a registration number, a serial number, a local area network address, a manufacturer number, a username, a combination thereof, or any other suitable value as will be apparent to persons having skill in the relevant art.

The social network identifier 306 may be a unique value associated with the consumer 102 for one or more social networks. In some embodiments, the consumer profile 208 may include more than one social network identifier 306. The social network identifier 306 may be a username, e-mail address, web address, handle, identification number, or other suitable value as will be apparent to persons having skill in the relevant art. In some embodiments, the consumer profile 208 may also include an indication as to the social network associated with each social network identifier 306. In some instances, the associated social network may be identified based on the social network identifier 306 itself (e.g., based on the formatting of the social network identifier 306).

The social network preferences 308 may include one or more preferences of the consumer 102 with regard to at least one of: transaction data preferences (e.g., what transaction data is to be included in generated social network messages), privacy settings (e.g., who may view published content), display settings, groups for display (e.g., for selection for viewing of a published message), tagging preferences, geographic location preferences, and follower settings (e.g., requiring consumers be followers to view published content). Additional preferences will be apparent to persons having skill in the relevant art. In embodiments where the consumer profile 208 may include more than one social network identifier 306, the social network preferences 308 may include preferences regarding priority and/or selection of the corresponding social networks for the publishing of the social network message.

The social network history 310 may include transaction data and additional information regarding generated social network messages transmitted to the social network operators 106 for publishing. The processing server 108 may use the social network history 310 to identify eligible offers for distribution to the corresponding consumer 102 based on limitations associated with the respective offers and the social network history 310. In some embodiments, the processing server 108 may analyze the social network history 310 or distribute the social network history 310 to a third party for analysis. In such an embodiment, the processing server 108 may distribute the social network history 310 stripped of any personally identifiable information and/or with the permission of the corresponding consumer 102.

### Process for Generating and Approving a Social Network Message for Publishing

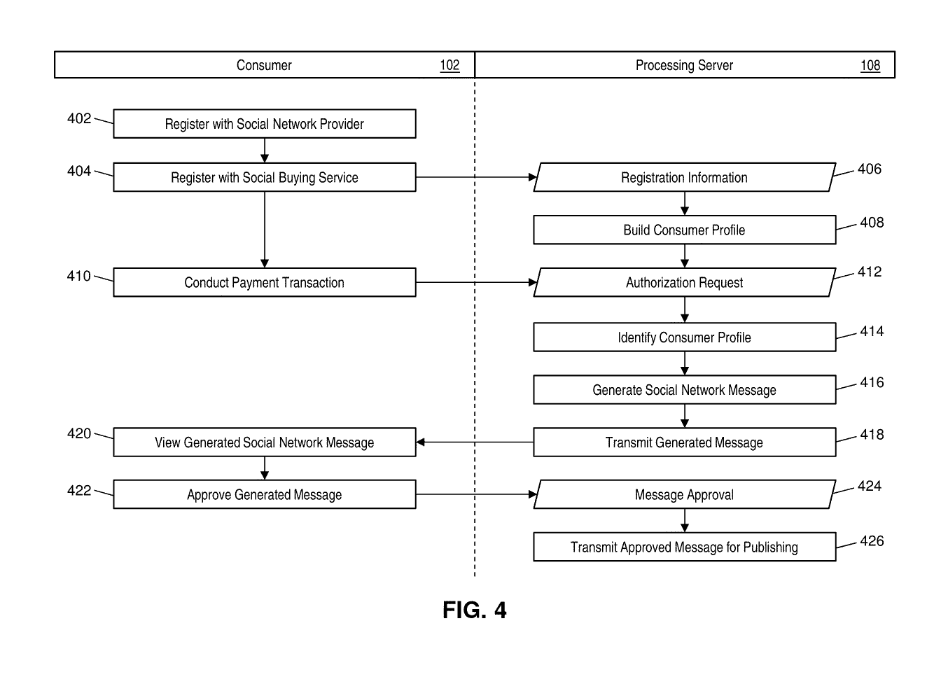

FIG. 4 illustrates a process for the generation of a social network message linked with payment transaction data and approval thereof by a consumer for publishing.

In step 402, the consumer 102 may register for a social network operated by the social network operator 106. Registration with the social network operator 106 may include the identification and/or generation of a social network identifier 306 associated with the consumer 102 with the respective social network. In step 404, the consumer 102 may register with a social buying service operated by the processing server 108. In step 406, the processing server 108 may receive (e.g., via the receiving unit 202) the registration information, which may include the consumer identifier 302, the device identifier 304, and the social network identifier 306. In some embodiments, the registration information may further include one or more social network preferences 308.

In step 408, the processing server 108 may generate and store (e.g., via the processing unit 204) a consumer profile 208 for the consumer 102 in the profile database 110 using the registration information. In step 410, the consumer 102 may conduct a payment transaction with the merchant 112. The payment transaction may be processed by the payment network 114. In step 412, the processing server 108 may receive an authorization request for the payment transaction conducted by the consumer 102 and processed by the payment network 114, wherein the authorization request includes at least the consumer identifier 302 and transaction data.

In step 414, the processing unit 204 of the processing server 108 may identify, in the profile database 110, the consumer profile 208 corresponding to the consumer 102 based on the consumer identifier 302 included in the authorization request. In step 416, the processing server 108 may generate a social network message based on the transaction data to be published by the social network that the consumer 102 is registered with. In step 418, the transmitting unit 206 of the processing server 108 may transmit the generated social network message to the computing device 104 associated with the device identifier 304 of the consumer profile 208.

In step 420, the consumer 102 may view the generated social network message using the computing device 104. In step 422, the consumer 102 may make any changes or modifications to the social network message or preferences for publishing of the message and may input an approval of the generated message into the computing device 104. The computing device 104 may then transmit the approval to the processing server 108, which may receive the approval in step 424. The processing unit 204 may update the generated social network message if necessary based on the received approval message. In step 426, the transmitting unit 206 may transmit the generated (e.g., and updated) social network message to the social network operator 106 for publishing.

### Method for Generating a Linked Social Network Message

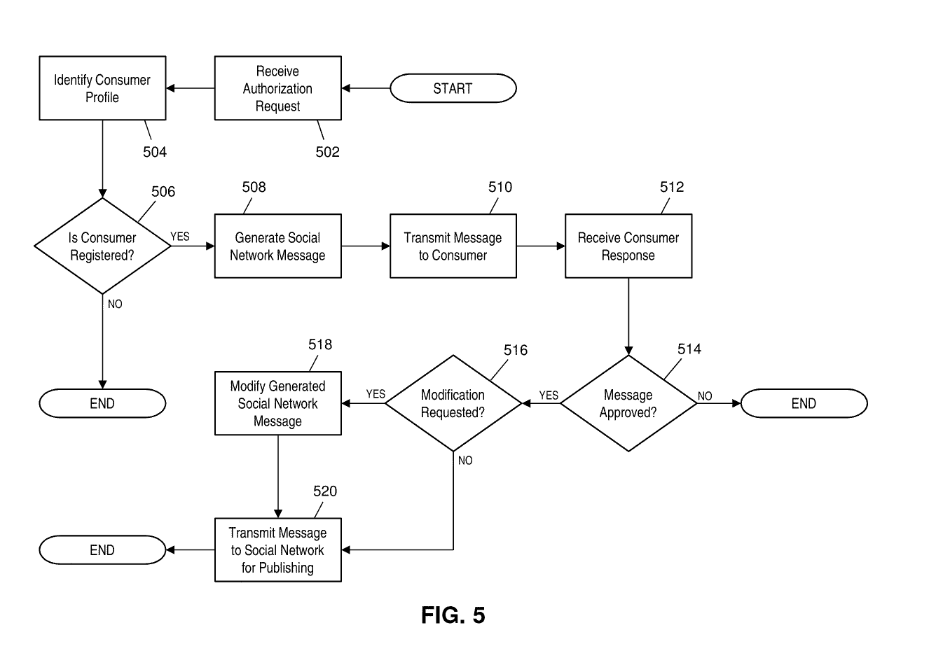

FIG. 5 illustrates a method for the generation of a social network message based on payment transaction data by the processing server 108.

In step 502, the receiving unit 202 of the processing server 108 may receive an authorization request for a payment transaction, wherein the authorization request includes a consumer identifier 302 and transaction data. The transaction data may include, for example, a merchant name, merchant category, payment data, product data, a transaction amount, a transaction time and/or date, and a geographic location. In step 504, the processing unit 204 of the processing server 108 may identify a consumer profile 208 in the profile database 110 where the included consumer identifier 302 corresponds to the consumer identifier 302 included in the authorization request.

In step 506, the processing unit 204 may determine if the consumer 102 associated with the identified consumer profile 208 is registered with the social buying service. If the consumer 102 is not registered, then the process may end. If the consumer 102 is registered, then, in step 508, the processing server 108 may generate a social network message based on the transaction data included in the authorization request. In step 510, the transmitting unit 206 of the processing server 108 may transmit the generated social network message to a computing device 104 associated with the device identifier 304 included in the consumer profile 208.

In step 512, the receiving unit 202 may receive a response from the consumer 102 regarding the generated social network message. In step 514, the processing unit 204 may identify, in the consumer response, if the social network message was approved. If the generated message was not approved, then the method may end. In some embodiments, the processing server 108 may request modification of the social network message by the consumer 102 or notify the merchant 112 of the denial of the generated social network message.

If the message was approved, then, in step 516, the processing unit 204 may identify if modification of the generated social network message was requested by the consumer 102. If modification was requested, then the processing unit 204 may modify the social network message pursuant to the requested modifications in step 518. Once the message has been modified, or if no modification was requested, then, in step 520, the transmitting unit 206 may transmit the social network message to the social network operator 106 for publishing.

### Method for Identifying and Distributing Offers Based on Publishing Social Network Content

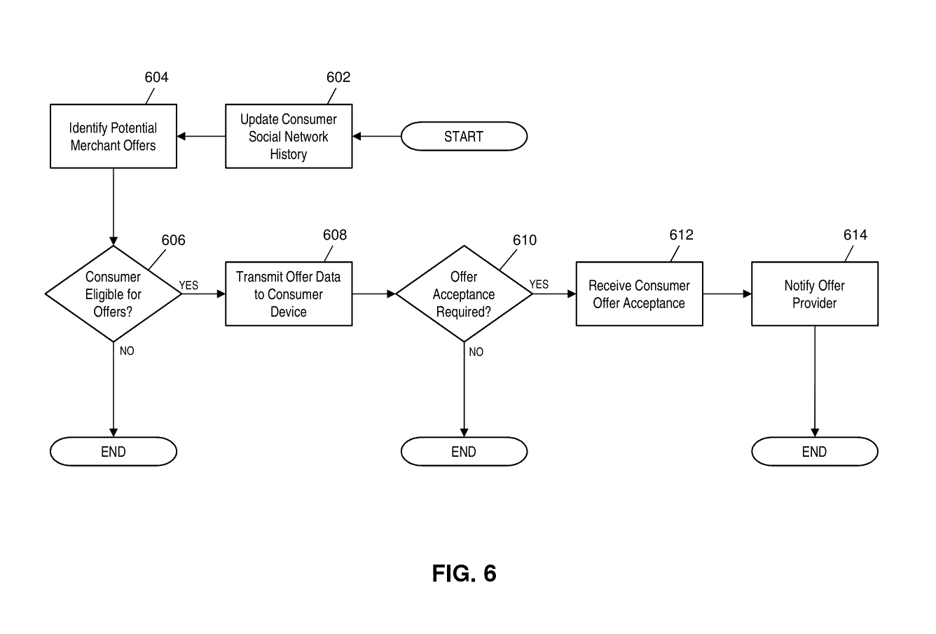

FIG. 6 illustrates a method for the identification and distribution of offers based on social network messages published via the method illustrated of FIG. 5.

In step 602, the processing unit 204 may update the social network history 310 of the consumer 102 in the corresponding consumer profile 208 based on a social network message generated and transmitted to the social network operator 106 following a payment transaction involving the consumer 102. The data regarding the social network message stored in the social network history 310 may include the transaction data, the social network message, user preferences, publishing settings or preferences, and other data that will be apparent to persons having skill in the relevant art.

In step 604, the processing unit 204 may identify offer data entries 212 stored in the offer database 210 related to offers for which the consumer 102 may be eligible based on offer data and/or limitations included in the respective offer data entries 212 and the social network history 310 of the consumer profile 208. In step 606, the processing unit 204 may identify if any eligible offers were identified in the previous step. If the processing unit 204 identifies that the consumer 102 is not eligible for any offers at that point in time, then the process may be completed.

If, on the other hand, the processing unit 204 determines that the consumer 102 is eligible for one or more offers, then, in step 608, the processing unit 204 may transmit offer data for the one or more offers to the computing device 104 of the consumer 102 for viewing by the consumer 102. In embodiments where the consumer 102 may be eligible for more than one offer, the processing unit 204 may be configured to select a single offer for distribution to the consumer 102. In further embodiments, the processing unit 204 may select the single offer based on one or more targeting rules or models, such as using consumer data, social network history 310, transaction data, demographic data, and other data that will be apparent to persons having skill in the relevant art.

In step 610, the processing unit 204 may determine if each offer distributed to the consumer 102 is required to be accepted by the consumer 102 for use. It will be apparent to persons having skill in the relevant art that some offers may be freely used by the consumer 102, whereas other offers may require acceptance and/or purchasing by the consumer 102 prior to their use (e.g., for exclusivity, tracking, targeting, etc.). If no acceptance is required for any distributed offer, then the method may be completed.

If acceptance is required, then, in step 612, the receiving unit 202 may receive acceptance of one or more offers by the consumer 102. In step 614, the transmitting unit 206 may forward the acceptance of each offer to a respective offer provider. The transmitting unit 206 may further provide any additional data requested by the offer provider regarding acceptance of an offer, such as the consumer identifier 302 associated with the consumer 102. It should be noted that the method illustrated in FIG. 6 is provided as an illustration only, and that additional systems and methods for distributing and receiving acceptance of offers by a consumer will be apparent to persons having skill in the relevant art.

### Exemplary Method for Generating a Social Network Message Based on a Payment Transaction

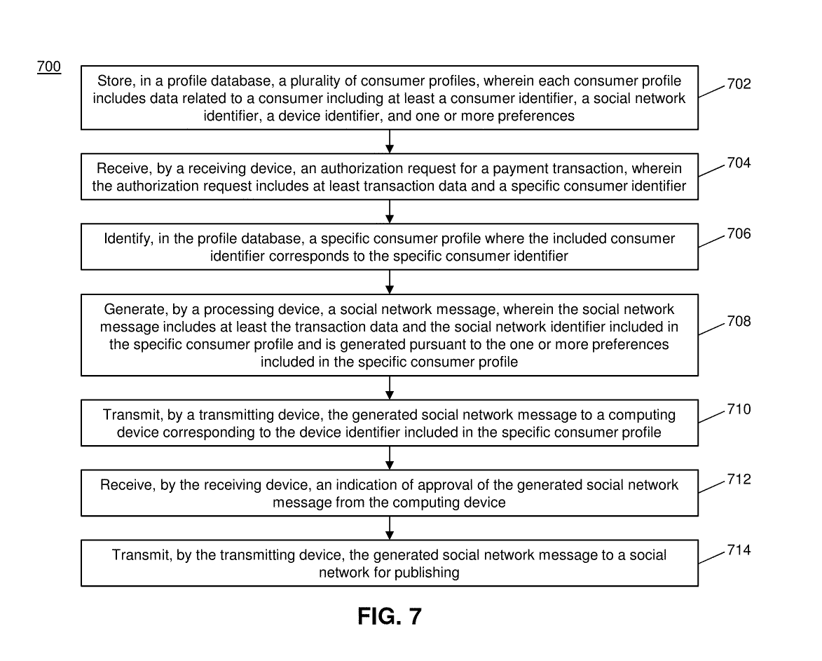

FIG. 7 illustrates an exemplary method 700 for the generation of a social network message based on transaction data of a payment transaction involving a consumer (e.g., the consumer 102).

In step 702, a plurality of consumer profiles (e.g., consumer profiles 208) may be stored in a profile database (e.g., the profile database 110), wherein each consumer profile 208 includes data related to a consumer 102 including at least a consumer identifier (e.g., the consumer identifier 302), a social network identifier (e.g., the social network identifier 306), a device identifier (e.g., the device identifier 304), and one or more preferences (e.g., the social network preferences 308). In some embodiments, the one or more preferences 308 may include at least one of: transaction data preferences, privacy settings, display settings, groups for display, tagging preferences, geographic location preferences, and follower settings. In one embodiment, the consumer identifier 302 may include at least one of: a payment account number, name, phone number, e-mail address, and street address. In another embodiment, the consumer identifier 302 and the device identifier 304 may be the same value.

In step 704, a receiving device (e.g., the receiving unit 202) may receive an authorization request for a payment transaction, wherein the authorization request includes at least transaction data and a specific consumer identifier. In one embodiment, the transaction data may include at least one of: merchant name, merchant category, merchant identifier, payment details, product data, transaction amount, transaction time and/or date, and transaction geographic location. In step 706, a specific consumer profile 208 may be identified, in the profile database 110, where the included consumer identifier 302 corresponds to the specific consumer identifier.

In step 708, a social network message may be generated, by a processing device (e.g., the processing unit 204), wherein the social network message includes at least the transaction data and the social network identifier 306 included in the specific consumer profile 208 and is generated pursuant to the one or more preferences 308 included in the specific consumer profile 208. In step 710, the generated social network message may be transmitted, by a transmitting device (e.g., the transmitting unit 206) to a computing device (e.g., the computing device 104) corresponding to the device identifier included in the specific consumer profile. In one embodiment, the computing device 104 may be a mobile computing device. In a further embodiment, transmitting the generated social network message to the computing device 104 may include transmitting the generated social network message for display on the computing device 104 via an application program executed by the mobile computing device.

In step 712, an indication of approval of the generated social network may be received, by the receiving device 202, from the computing device 104. In step 714, the generated social network message may be transmitted, by the transmitting device 206, to a social network for publishing. In another embodiment, the indication of approval may include one or more modifications to the generated social network message, and the method 700 may further include updating, by the processing device 204, the generated social network message to incorporate the one or more modifications prior to transmitting the generated social network message.

In one embodiment, the transaction data may include at least a specific merchant identifier and the method 700 may further include: storing, in an offer database (e.g., the offer database 210), a plurality of offer data entries (e.g., offer data entries 212), wherein each offer data entry 210 includes data related to an offer for the purchase of goods or services including at least offer data and a merchant identifier; identifying, in the offer database 210, one or more offer data entries 212 where the included merchant identifier corresponds to the specific merchant identifier; and transmitting, by the transmitting device 206, the offer data included in each of the identified one or more offer data entries 212 to the computing device 104. In a further embodiment, the offer data may include at least one of: offer name, offer description, offer amount, offer type, offer category, product name, product description, product category, start date, end date, quantity, and limitations on redemption.

### Computer System Architecture

FIG. 8 illustrates a computer system 800 in which embodiments of the present disclosure, or portions thereof, may be implemented as computer-readable code. For example, the processing server 108 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 4-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for generating a social network message based on a payment transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating a social network message linked to a payment transaction, comprising
storing, in a profile database, a plurality of consumer profiles, wherein each consumer profile includes data related to a consumer including at least a consumer identifier, a social network identifier, a device identifier, and one or more preferences;
receiving, by a receiving device, an authorization request for a payment transaction, wherein the authorization request includes at least transaction data and a specific consumer identifier;
identifying, in the profile database, a specific consumer profile wherein the included consumer identifier corresponds to the specific consumer identifier;
generating, by a processing device, a social network message, where the social network message includes at least the transaction data and the social network identifier included in the specific consumer profile and is generated pursuant to the one or more preferences included in the specific consumer profile;
transmitting, by a transmitting device, the generated social network message to a computing device corresponding to the device identifier included in the specific consumer profile;
receiving, by the receiving device, an indication of approval of the generated social network message from the computing device; and
transmitting, by the transmitting device, the generated social network message to a social network for publishing.

2. The method of claim 1, wherein the transaction data includes at least a specific merchant identifier, and the method further comprises:
storing, in an offer database, a plurality of offer data entries, wherein each offer data entry includes data related to an offer for the purchase of goods or services including at least offer data and a merchant identifier;
identifying, in the offer database, one or more offer data entries where the included merchant identifier corresponds to the specific merchant identifier; and
transmitting, by the transmitting device, the offer data included in each of the identified one or more offer data entries to the computing device.

3. The method of claim 2, wherein the offer data includes at least one of: offer name, offer description, offer amount, offer type, offer category, product name, product description, product category, start date, end date, quantity, and limitations on redemption.

4. The method of claim 1, wherein the indication of approval includes one or more modifications to the generated social network message, and the method further comprises:
updating, by the processing device, the generated social network message to incorporate the one or more modifications prior to transmitting the generated social network message.

5. The method of claim 1, wherein the computing device is a mobile computing device.

6. The method of claim 5, wherein transmitting the generated social network message to the computing device includes transmitting the generated social network message for display on the computing device via an application program.

7. The method of claim 1, wherein the one or more preferences includes at least one of: transaction data preferences, privacy settings, display settings, groups for display, tagging preferences, geographic location preferences, and follower settings.

8. The method of claim 1, wherein the transaction data includes at least one of: merchant name, merchant category, payment details, product data, transaction amount, transaction time and/or date, and transaction geographic location.

9. The method of claim 1, wherein the consumer identifier includes at least one of: a payment account number, name, phone number, e-mail address, and street address.

10. The method of claim 1, wherein the consumer identifier and the device identifier are the same value.

11. A system for generating a social network message linked to a payment transaction, comprising
a profile database configured to store a plurality of consumer profiles, wherein each consumer profile includes data related to a consumer including at least a consumer identifier, a social network identifier, a device identifier, and one or more preferences;
a receiving device configured to receive an authorization request for a payment transaction, wherein the authorization request includes at least transaction data and a specific consumer identifier;
a processing device configured to
identify, in the profile database, a specific consumer profile where the included consumer identifier corresponds to the specific consumer identifier, and
generate a social network message, wherein the social network message includes at least the transaction data and the social network identifier included in the specific consumer profile and is generated pursuant to the one or more preferences included in the specific consumer profile; and
a transmitting device configured to transmit the generated social network message to a computing device corresponding to the device identifier included in the specific consumer profile, wherein
the receiving device is further configured to receive an indication of approval of the generated social network message from the computing device, and
the transmitting device is further configured to transmit the generated social network message to a social network for publishing.

12. The system of claim 11, further comprising:
an offer database, wherein
the transaction data includes at least a specific merchant identifier,
the offer database is configured to store a plurality of offer data entries, wherein each offer data entry includes data related to an offer for the purchase of goods or services including at least offer data and a merchant identifier,
the processing device is further configured to identify, in the offer database, one or more offer data entries where the included merchant identifier corresponds to the specific merchant identifier, and
the transmitting device is further configured to transmit the offer data included in each of the identified one or more offer data entries to the computing device.

13. The system of claim 12, wherein the offer data includes at least one of: offer name, offer description, offer amount, offer type, offer category, product name, product description, product category, start date, end date, quantity, and limitations on redemption.

14. The system of claim 11, wherein
the indication of approval includes one or more modifications to the generated social network message, and
the processing device is further configured to update the generated social network message to incorporate the one or more modifications prior to transmitting the generated social network message.

15. The system of claim 11, wherein the computing device is a mobile computing device.

16. The system of claim 15, wherein transmitting the generated social network message to the computing device includes transmitting the generated social network message for display on the computing device via an application program.

17. The system of claim 11, wherein the one or more preferences includes at least one of: transaction data preferences, privacy settings, display settings, groups for display, tagging preferences, geographic location preferences, and follower settings.

18. The system of claim 11, wherein the transaction data includes at least one of: merchant name, merchant category, payment details, product data, transaction amount, transaction time and/or date, and transaction geographic location.

19. The system of claim 11, wherein the consumer identifier includes at least one of: a payment account number, name, phone number, e-mail address, and street address.

20. The system of claim 11, wherein the consumer identifier and the device identifier are the same value.
